(19) United States
(12) Patent Application Publication
(10) Pub. No.: US 2017/0109474 A1
(43) Pub. Date: Apr. 20, 2017

(54) METHOD FOR PROVIDING HEALTH INFORMATION AND ELECTRONIC DEVICE IMPLEMENTING THE SAME

(71) Applicant: Samsung Electronics Co., Ltd., Gyeonggi-do (KR)

(72) Inventors: Sun Ok JUNG, Gyeonggi-do (KR); Dongjin KOH, Seoul (KR); Dongwook KIM, Seoul (KR); Hyejung SEO, Gyeonggi-do (KR); Inji JIN, Gyeonggi-do (KR)

(21) Appl. No.: 15/240,023

(22) Filed: Aug. 18, 2016

(30) Foreign Application Priority Data
Oct. 19, 2015 (KR) 10-2015-0145334

(51) Int. Cl. G06F 19/00; G08B 21/02

(52) U.S. Cl. CPC G06F 19/322; G08B 21/02

(57) ABSTRACT

Various embodiments provide a method and an apparatus configured to include a communication interface, a sensor, a memory for storing health information on a user of the electronic device, and a processor, wherein the processor may be configured to obtain biometric information on a user corresponding to the electronic device using an external device functionally connected to a sensor or the electronic device, determine whether the user is in an emergency situation at least on the basis of the biometric information, and differently provide health information corresponding to the user depending on situations of the electronic device when the user is in the emergency situation. Further, other embodiments are also possible.

### CLAIM OF PRIORITY

This application claims the priority under 35 U.S.C. §119(a) to Korean Application Serial No. 10-2015-0145334, which was filed in the Korean Intellectual Property Office on Oct. 19, 2015, the entire content of which is hereby incorporated by reference.

### TECHNICAL FIELD

The present disclosure relates to electronic devices, in general, and more particularly to a method and apparatus for providing health information.

### BACKGROUND

With development of a digital technology, electronic devices, which can process communication and personal information while moving, such as a mobile communication terminal, a Personal Digital Assistant (PDA), an electronic scheduler, a smart phone, a tablet Personal Computer (PC), and a wearable device have been variously launched. The electronic devices provide various services related to photographing, navigation, and payment. Therefore, the user is able to use various functions through one electronic device even though the user does not have a camera for photographing, a navigation device for finding a route, or a card or cash for payment. Therefore, the electronic device may further improve convenience of the user.

Meanwhile, the electronic device provides a function of obtaining and managing health information. For example, the electronic device may provide health information obtained when the user is in an emergency situation. However, there is inconvenience in that health information to be provided when the user is in the emergency situation should be previously configured in the electronic device. Further, since the electronic device determines that the user is in the emergency situation when an emergency hot key is pressed, and in the case where it is not an emergency situation, there is a problem in that the user's health information may be exposed when the emergency hot key is pressed despite not being in an emergency situation.

### SUMMARY

Various embodiments may provide a method and apparatus for properly providing health information step by step according to the emergency situation without separate configuration by a user for open information while protecting personal information even when the user is in an emergency situation.

An electronic device according to various embodiments, may include a communication module, a sensor, a memory for storing health information on a user of the electronic device, and a processor, wherein the processor may be configured to obtain biometric information on a user corresponding to the electronic device, determine whether the user is in an emergency situation at least on the basis of the biometric information, and differently provide health information corresponding to the user depending on a situation of the electronic device when the user is in the emergency situation.

An operation method of the electronic device according to various embodiments may include operations of: obtaining biometric information on a user corresponding to the electronic device from an external device functionally connected to a sensor or an external device; determining whether the user is in an emergency situation at least on the basis of the biometric information; and differently providing health information corresponding to the user depending on a situation of the electronic device when the user is in the emergency situation.

A computer readable recoding medium according to various embodiments may include a program for performing operations of: obtaining biometric information on a user corresponding to the electronic device from a sensor or an external device; determining whether the user is in an emergency situation at least on the basis of the biometric information; and differently providing health information corresponding to the user depending on a situation of the electronic device when the user is in the emergency situation.

According to various embodiments, when the user is in the emergency situation, security is configured for the electronic device so that the user's personal information can be protected.

According to various embodiments, by providing only primary information for the emergency situation, only information required in the emergency situation may be provided while protecting the user's personal information in a state in which the user is unconscious.

According to various embodiments, the information required in the emergency situation of the user is transmitted to the hospital when the user approaches a hospital so that the hospital can be ready for emergency treatment in advance.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a diagram illustrating an example of a network environment, according to various embodiments;

FIG. 2 is a block diagram of an example of an electronic device, according to various embodiments;

FIG. 3 is a block diagram of an example of a program module, according to various embodiments;

FIG. 4 is a diagram illustrating an example of a technique for providing health information, according to various embodiments;

FIG. 5 is a flowchart of an example of a process, according to various embodiments;

FIG. 6 is a flowchart of an example of a process, according to various embodiments;

FIG. 7 illustrates an example of a first health information, according to various embodiments;

FIG. 8 is a flowchart of an example of a process, according to various embodiments;

FIG. 9A illustrates an example of second heath information, according to various embodiments;

FIG. 9B illustrates an example of a second heath information, according to various embodiments; and

FIG. 10 is a flowchart of an example of a process, according to various embodiments.

### DETAILED DESCRIPTION

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B. The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms used in the present disclosure are only used to describe specific embodiments, and are not intended to limit the present disclosure. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit).

According to some embodiments, the electronic device may be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology.

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

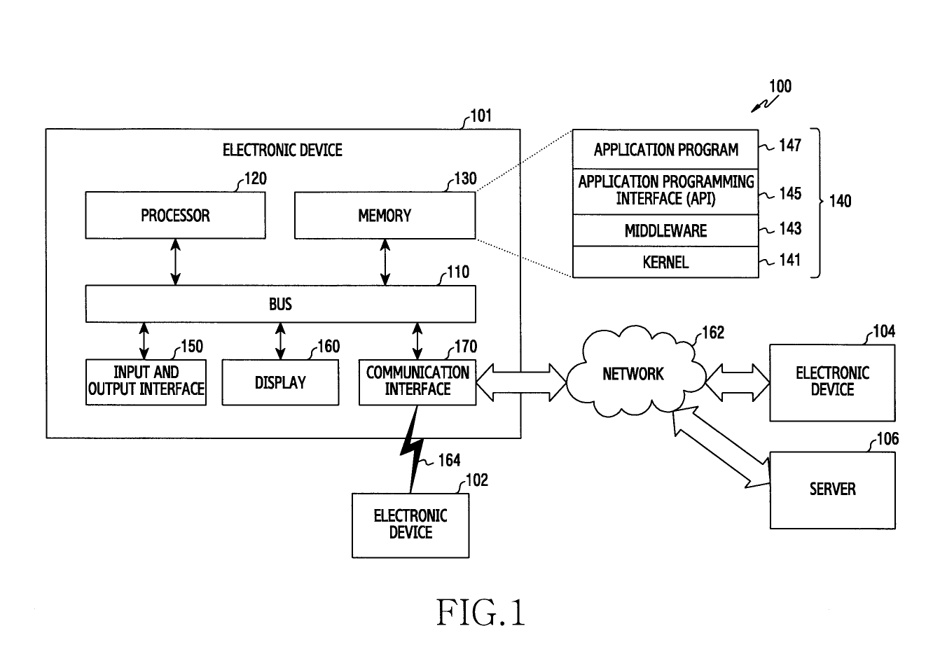

FIG. 1 is a diagram illustrating an example of a network environment 100, according to various embodiments. As illustrated, the network environment 100 may include an electronic device 101. The electronic device 101 may include a bus 110, a processor 120, a memory 130, an input/output interface 150, a display 160, and a communication interface 170. According to an embodiment of the present disclosure, the electronic device 101 may omit at least one of the above components or may further include other components.

The bus 110 may include, for example, a circuit which interconnects the components 110 to 170 and delivers a communication (e.g., a control message and/or data) between the components 110 to 170.

The processor 120 may include a microprocessor or any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), a Graphical Processing Unit (GPU), a video card controller, etc. In operation, the processor 120 may carry out, for example, calculation or data processing relating to control and/or communication of at least one other component of the electronic device 101. The processor 120 may obtain biometric information on a user corresponding to the electronic device from an external device functionally connected to a sensor or the electronic device 101, determine whether the user is in an emergency situation at least on the basis of the biometric information, and differently provide health information corresponding to the user depending on situations of the electronic device when it is determined that the user is in the emergency situation.

The memory 130 may include any suitable type of volatile or non-volatile memory, such as Random-access Memory (RAM), Read-Only Memory (ROM), Network Accessible Storage (NAS), cloud storage, a Solid State Drive (SSD), etc. In operation, the memory 130 may store, for example, commands or data relevant to at least one other component of the electronic device 101. According to an embodiment of the present disclosure, the memory 130 may store software and/or a program 140. The memory 130 may store health information regarding the user of the electronic device 101. The program 140 may include, for example, a kernel 141, middleware 143, an Application Programming Interface (API) 145, and/or application programs (or “applications”) 147. At least some of the kernel 141, the middleware 143, and the API 145 may be referred to as an Operating System (OS).

The kernel 141 may control or manage system resources (e.g., the bus 110, the processor 120, or the memory 130) used for performing an operation or function implemented in the other programs (e.g., the middleware 143, the API 145, or the application programs 147). Furthermore, the kernel 141 may provide an interface through which the middleware 143, the API 145, or the application programs 147 may access the individual components of the electronic device 101 to control or manage the system resources. The middleware 143, for example, may serve as an intermediary for allowing the API 145 or the application programs 147 to communicate with the kernel 141 to exchange data.

Also, the middleware 143 may process one or more task requests received from the application programs 147 according to priorities thereof. For example, the middleware 143 may assign priorities for using the system resources (e.g., the bus 110, the processor 120, the memory 130, or the like) of the electronic device 101, to at least one of the application programs 147. For example, the middleware 143 may perform scheduling or loading balancing on the one or more task requests by processing the one or more task requests according to the priorities assigned thereto.

The API 145 is an interface through which the applications 147 control functions provided from the kernel 141 or the middleware 143, and may include, for example, at least one interface or function (e.g., instruction) for file control, window control, image processing, character control, and the like.

The input/output interface 150, for example, may function as an interface that may transfer commands or data input from a user or another external device to the other element(s) of the electronic device 101. Furthermore, the input/output interface 150 may output the commands or data received from the other element(s) of the electronic device 101 to the user or another external device.

Examples of the display 160 may include a Liquid Crystal Display (LCD), a Light-Emitting Diode (LED) display, an Organic Light-Emitting Diode (OLED) display, a MicroElectroMechanical Systems (MEMS) display, and an electronic paper display. The display 160 may display, for example, various types of contents (e.g., text, images, videos, icons, or symbols) to users. The display 160 may include a touch screen, and may receive, for example, a touch, gesture, proximity, or hovering input using an electronic pen or a user's body part.

The communication interface 170 may establish communication, for example, between the electronic device 101 and an external device (e.g., a first external electronic device 102, a second external electronic device 104, or a server 106). For example, the communication interface 170 may be connected to a network 162 through wireless or wired communication, and may communicate with an external device (e.g., the second external electronic device 104 or the server 106). The wireless communication may use at least one of, for example, Long Term Evolution (LTE), LTE-Advance (LTE-A), Code Division Multiple Access (CDMA), Wideband CDMA (WCDMA), Universal Mobile Telecommunications System (UMTS), Wireless Broadband (WiBro), and Global System for Mobile Communications (GSM), as a cellular communication protocol. In addition, the wireless communication may include, for example, short range communication 164. The short-range communication 164 may include at least one of, for example, Wi-Fi, Bluetooth, Near Field Communication (NFC), and Global Navigation Satellite System (GNSS). GNSS may include, for example, at least one of global positioning system (GPS), global navigation satellite system (Glonass), Beidou Navigation satellite system (Beidou) or Galileo, and the European global satellite-based navigation system, based on a location, a bandwidth, or the like. Hereinafter, in the present disclosure, the “GPS” may be interchangeably used with the “GNSS”. The wired communication may include, for example, at least one of a Universal Serial Bus (USB), a High Definition Multimedia Interface (HDMI), Recommended Standard 232 (RS-232), and a Plain Old Telephone Service (POTS). The network 162 may include at least one of a telecommunication network such as a computer network (e.g., a LAN or a WAN), the Internet, and a telephone network.

Each of the first and second external electronic devices 102 and 104 may be of a type identical to or different from that of the electronic device 101. According to an embodiment of the present disclosure, the server 106 may include a group of one or more servers. According to various embodiments of the present disclosure, all or some of the operations performed in the electronic device 101 may be executed in another electronic device or a plurality of electronic devices (e.g., the electronic devices 102 and 104 or the server 106). According to an embodiment of the present disclosure, when the electronic device 101 has to perform some functions or services automatically or in response to a request, the electronic device 101 may request another device (e.g., the electronic device 102 or 104 or the server 106) to execute at least some functions relating thereto instead of or in addition to autonomously performing the functions or services. Another electronic device (e.g., the electronic device 102 or 104, or the server 106) may execute the requested functions or the additional functions, and may deliver a result of the execution to the electronic device 101. The electronic device 101 may process the received result as it is or additionally, and may provide the requested functions or services. To this end, for example, cloud computing, distributed computing, or client-server computing technologies may be used.

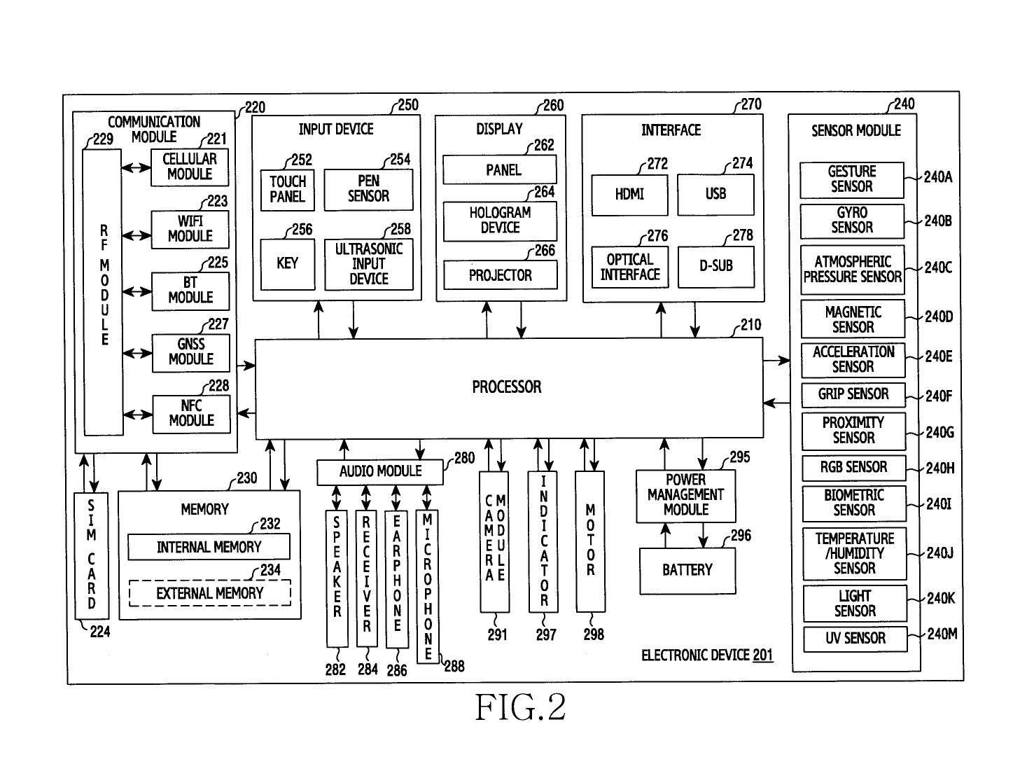

FIG. 2 is a block diagram of an example of an electronic device 201, according to various embodiments of the present disclosure.

The electronic device 201 may include, for example, all or a part of the electronic device 101 shown in FIG. 1. The electronic device 201 may include one or more processors 210 (e.g., Application Processors (AP)), a communication module 220, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software components connected to the processor 210 by driving an operating system or an application program, and perform processing of various pieces of data and calculations. The processor 210 may be embodied as, for example, a System on Chip (SoC). According to an embodiment of the present disclosure, the processor 210 may further include a Graphic Processing Unit (GPU) and/or an image signal processor. The processor 210 may include at least some (for example, a cellular module 221) of the components illustrated in FIG. 2. The processor 210 may load, into a volatile memory, commands or data received from at least one (e.g., a non-volatile memory) of the other components and may process the loaded commands or data, and may store various data in a non-volatile memory.

The processor 210 may obtain biometric information on a user corresponding to the electronic device 201 from an external device functionally connected to a sensor module 240 or an electronic device 201, determine whether the user is in an emergency situation at least on the basis of the biometric information, and differently provide health information corresponding to the user depending on situations of the electronic device when it is determined that the user is in the emergency situation. For example, the processor 210 may provide the health information using first information providing method when a first situation is an emergency situation, and provide the health information using a second information providing method when a second situation is the emergency situation. The processor 210 may display at least a part of the health information through a display 260 functionally connected to the electronic device 201. The processor 210 may transmit at least a part of the health information using a communication module 220 according to the emergency situations.

The communication module 220 may have a configuration equal or similar to that of the communication interface 170 of FIG. 1. The communication module 220 may include, for example, a cellular module 221, a Wi-Fi module 223, a BT module 225, a GNSS module 227 (e.g., a GPS module 227, a Glonass module, a Beidou module, or a Galileo module), an NFC module 228, and a Radio Frequency (RF) module 229.

The cellular module 221, for example, may provide a voice call, a video call, a text message service, or an Internet service through a communication network. According to an embodiment of the present disclosure, the cellular module 221 may distinguish and authenticate the electronic device 201 in a communication network using a subscriber identification module (e.g: SIM card) 224 (for example, the SIM card). According to an embodiment of the present disclosure, the cellular module 221 may perform at least some of the functions that the AP 210 may provide. According to an embodiment of the present disclosure, the cellular module 221 may include a communication processor (CP).

For example, each of the Wi-Fi module 223, the BT module 225, the GNSS module 227, and the NFC module 228 may include a processor for processing data transmitted/received through a corresponding module. According to an embodiment of the present disclosure, at least some (e.g., two or more) of the cellular module 221, the Wi-Fi module 223, the BT module 225, the GNSS module 227, and the NFC module 228 may be included in one Integrated Chip (IC) or IC package.

The RF module 229, for example, may transmit/receive a communication signal (e.g., an RF signal). The RF module 229 may include, for example, a transceiver, a Power Amplifier Module (PAM), a frequency filter, a Low Noise Amplifier (LNA), and an antenna. According to another embodiment of the present disclosure, at least one of the cellular module 221, the WIFI module 223, the BT module 225, the GNSS module 227, and the NFC module 228 may transmit/receive an RF signal through a separate RF module.

The subscriber identification module 224 may include, for example, a card including a subscriber identity module and/or an embedded SIM, and may contain unique identification information (e.g., an Integrated Circuit Card Identifier (ICCID)) or subscriber information (e.g., an International Mobile Subscriber Identity (IMSI)).

The memory 230 (e.g., the memory 130) may include, for example, an embedded memory 232 or an external memory 234. The embedded memory 232 may include at least one of a volatile memory (e.g., a Dynamic Random Access Memory (DRAM), a Static RAM (SRAM), a Synchronous Dynamic RAM (SDRAM), and the like) and a non-volatile memory (e.g., a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (e.g., a NAND flash memory or a NOR flash memory), a hard disc drive, a Solid State Drive (SSD), and the like).

The external memory 234 may further include a flash drive, for example, a Compact Flash (CF), a Secure Digital (SD), a Micro Secure Digital (Micro-SD), a Mini Secure Digital (Mini-SD), an eXtreme Digital (xD), a MultiMediaCard (MMC), a memory stick, or the like. The external memory 234 may be functionally and/or physically connected to the electronic device 201 through various interfaces.

The sensor module 240, for example, may measure a physical quantity or detect an operation state of the electronic device 201, and may convert the measured or detected information into an electrical signal. The sensor module 240 may include, for example, at least one of a gesture sensor 240A, a gyro sensor 240B, an atmospheric pressure sensor (barometer) 240C, a magnetic sensor 240D, an acceleration sensor 240E, a grip sensor 240F, a proximity sensor 240G, a color sensor 240H (e.g., red, green, and blue (RGB) sensor), a biometric sensor (medical sensor) 2401, a temperature/humidity sensor 240J, an illuminance sensor 240K, and a Ultra Violet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an Infrared (IR) sensor, an iris scan sensor, and/or a finger scan sensor. The sensor module 240 may further include a control circuit for controlling one or more sensors included therein. According to an embodiment of the present disclosure, the electronic device 201 may further include a processor configured to control the sensor module 240, as a part of the processor 210 or separately from the processor 210, and may control the sensor module 240 while the processor 210 is in a sleep state.

The input device 250 may include, for example, a touch panel 252, a (digital) pen sensor 254, a key 256, or an ultrasonic input device 258. The touch panel 252 may use, for example, at least one of a capacitive type, a resistive type, an infrared type, and an ultrasonic type. The touch panel 252 may further include a control circuit. The touch panel 252 may further include a tactile layer, and provide a tactile reaction to the user.

The (digital) pen sensor 254 may include, for example, a recognition sheet which is a part of the touch panel or is separated from the touch panel. The key 256 may include, for example, a physical button, an optical key or a keypad. The ultrasonic input device 258 may detect, through a microphone (e.g., the microphone 288), ultrasonic waves generated by an input tool, and identify data corresponding to the detected ultrasonic waves.

The display 260 (e.g., the display 160) may include a panel 262, a hologram device 264, or a projector 266. The panel 262 may include a configuration identical or similar to the display 160 illustrated in FIG. 1. The panel 262 may be implemented to be, for example, flexible, transparent, or wearable. The panel 262 may be embodied as a single module with the touch panel 252. The hologram device 264 may show a three dimensional (3D) image in the air by using an interference of light. The projector 266 may project light onto a screen to display an image. The screen may be located, for example, in the interior of or on the exterior of the electronic device 201. According to an embodiment of the present disclosure, the display 260 may further include a control circuit for controlling the panel 262, the hologram device 264, or the projector 266.

The interface 270 may include, for example, a High-Definition Multimedia Interface (HDMI) 272, a Universal Serial Bus (USB) 274, an optical interface 276, or a D-subminiature (D-sub) 278. The interface 270 may be included in, for example, the communication interface 170 illustrated in FIG. 1. Additionally or alternatively, the interface 270 may include, for example, a Mobile High-definition Link (MHL) interface, a Secure Digital (SD) card/Multi-Media Card (MMC) interface, or an Infrared Data Association (IrDA) standard interface.

The audio module 280, for example, may bilaterally convert a sound and an electrical signal. At least some components of the audio module 280 may be included in, for example, the input/output interface 150 illustrated in FIG. 1. The audio module 280 may process voice information input or output through, for example, a speaker 282, a receiver 284, earphones 286, or the microphone 288.

The camera module 291 is, for example, a device which may photograph a still image and a video. According to an embodiment of the present disclosure, the camera module 291 may include one or more image sensors (e.g., a front sensor or a back sensor), a lens, an Image Signal Processor (ISP) or a flash (e.g., LED or xenon lamp).

The power management module 295 may manage, for example, power of the electronic device 201. According to an embodiment of the present disclosure, the power management module 295 may include a Power Management Integrated Circuit (PMIC), a charger Integrated Circuit (IC), or a battery or fuel gauge. The PMIC may use a wired and/or wireless charging method. Examples of the wireless charging method may include, for example, a magnetic resonance method, a magnetic induction method, an electromagnetic wave method, and the like. Additional circuits (e.g., a coil loop, a resonance circuit, a rectifier, etc.) for wireless charging may be further included. The battery gauge may measure, for example, a residual quantity of the battery 296, and a voltage, a current, or a temperature while charging. The battery 296 may include, for example, a rechargeable battery and/or a solar battery.

The indicator 297 may display a particular state (e.g., a booting state, a message state, a charging state, or the like) of the electronic device 201 or a part (e.g., the processor 210) of the electronic device 201. The motor 298 may convert an electrical signal into a mechanical vibration, and may generate a vibration, a haptic effect, or the like. Although not illustrated, the electronic device 201 may include a processing device (e.g., a GPU) for supporting a mobile TV. The processing device for supporting a mobile TV may process, for example, media data according to a certain standard such as Digital Multimedia Broadcasting (DMB), Digital Video Broadcasting (DVB), or mediaFLO™.

Each of the above-described component elements of hardware according to the present disclosure may be configured with one or more components, and the names of the corresponding component elements may vary based on the type of electronic device. In various embodiments, the electronic device may include at least one of the above-described elements. Some of the above-described elements may be omitted from the electronic device, or the electronic device may further include additional elements. Also, some of the hardware components according to various embodiments may be combined into one entity, which may perform functions identical to those of the relevant components before the combination.

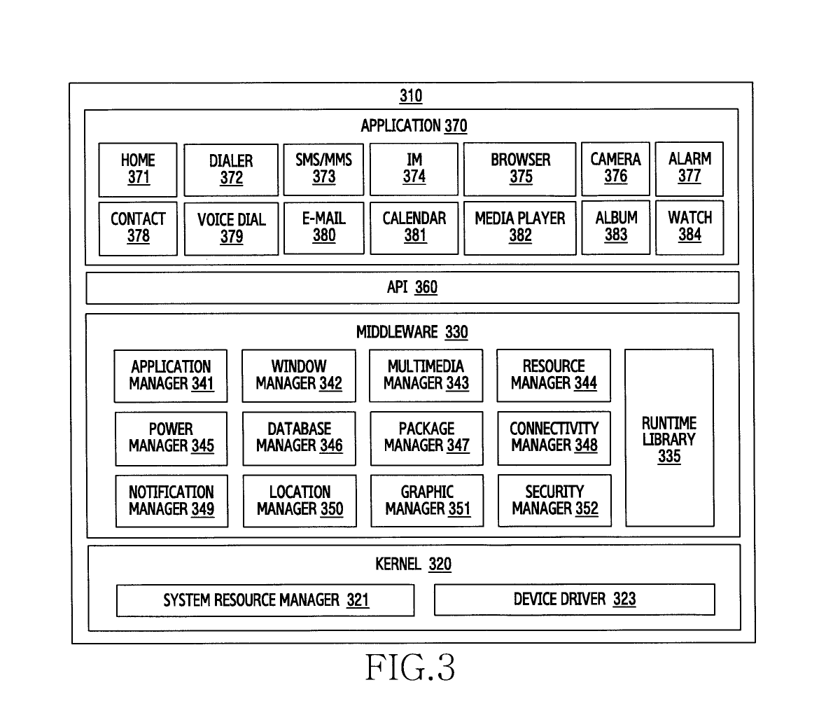

FIG. 3 is a block diagram of an example of a program, module according to various embodiments of the present disclosure.

According to an embodiment of the present disclosure, the program module 310 (e.g., the program 140) may include an Operating System (OS) for controlling resources related to the electronic device (e.g., the electronic device 101) and/or various applications (e.g., the application programs 147) executed in the operating system. The operating system may be, for example, Android™, iOS™, Windows™, Symbian™, Tizen™, Bada™, or the like.

The program module 310 may include a kernel 320, middleware 330, an API 360, and/or applications 370. At least some of the program module 310 may be preloaded on an electronic device, or may be downloaded from an external electronic device (e.g., the electronic device 102 or 104, or the server 106).

The kernel 320 (e.g., the kernel 141) may include, for example, a system resource manager 321 and/or a device driver 323. The system resource manager 321 may control, allocate, or collect system resources. According to an embodiment of the present disclosure, the system resource manager 321 may include a process management unit, a memory management unit, a file system management unit, and the like. The device driver 323 may include, for example, a display driver, a camera driver, a Bluetooth driver, a shared memory driver, a USB driver, a keypad driver, a Wi-Fi driver, an audio driver, or an Inter-Process Communication (IPC) driver.

For example, the middleware 330 may provide a function required in common by the applications 370, or may provide various functions to the applications 370 through the API 360 so as to enable the applications 370 to efficiently use the limited system resources in the electronic device. According to an embodiment of the present disclosure, the middleware 330 (e.g., the middleware 143) may include at least one of a run time library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses in order to add a new function through a programming language while an application 370 is being executed. The runtime library 335 may perform input/output management, memory management, the functionality for an arithmetic function, or the like.

The application manager 341 may manage, for example, a life cycle of at least one of the applications 370. The window manager 342 may manage Graphical User Interface (GUI) resources used by a screen. The multimedia manager 343 may recognize a format required for reproduction of various media files, and may perform encoding or decoding of a media file by using a codec suitable for the corresponding format. The resource manager 344 may manage resources of a source code, a memory, and a storage space of at least one of the applications 370.

The power manager 345 may operate together with, for example, a Basic Input/Output System (BIOS) or the like to manage a battery or power source and may provide power information or the like required for the operations of the electronic device. The database manager 346 may generate, search for, and/or change a database to be used by at least one of the applications 370. The package manager 347 may manage installation or an update of an application distributed in a form of a package file.

For example, the connectivity manager 348 may manage wireless connectivity such as Wi-Fi or Bluetooth. The notification manager 349 may display or otherwise output an indication of an event such as an indication of a message arrival, a proximity notification, and the like in such a way that does not disturb a user. The location manager 350 may manage location information of an electronic device. The graphic manager 351 may manage a graphic effect which will be provided to a user, or a user interface related to the graphic effect. The security manager 352 may provide all security functions required for system security, user authentication, or the like. According to an embodiment of the present disclosure, when the electronic device (e.g., the electronic device 101) has a telephone call function, the middleware 330 may further include a telephony manager for managing a voice call function or a video call function of the electronic device.

The middleware 330 may include a middleware module that forms a combination of various functions of the above-described components. The middleware 330 may provide a module specialized for each type of OS in order to provide a differentiated function. Further, the middleware 330 may dynamically remove some of the existing components or add new components.

The API 360 (e.g., the API 145) is, for example, a set of API programming functions, and may be provided with a different configuration according to an OS. For example, in the case of Android or iOS, one API set may be provided for each platform. In the case of Tizen, two or more API sets may be provided for each platform.

The applications 370 (e.g., the application programs 147) may include, for example, one or more applications which may provide functions such as a home 371, a dialer 372, an SMS/MMS 373, an Instant Message (IM) 374, a browser 375, a camera 376, an alarm 377, contacts 378, a voice dial 379, an email 380, a calendar 381, a media player 382, an album 383, a clock 384, health care (e.g., an amount of exercise a user has received or blood sugar), or environment information (e.g., providing atmospheric pressure, humidity, or temperature information).

According to an embodiment of the present disclosure, the applications 370 may include an application (hereinafter, referred to as an “information exchange application” for convenience of description) that supports exchanging information between the electronic device (e.g., the electronic device 101) and an external electronic device (e.g., the electronic device 102 or 104). The information exchange application may include, for example, a notification relay application for transferring specific information to an external electronic device or a device management application for managing an external electronic device.

For example, the notification relay application may include a function of transferring, to the external electronic device (e.g., the electronic device 102 or 104), notification information generated from other applications of the electronic device 101 (e.g., an SMS/MMS application, an e-mail application, a health management application, or an environmental information application). Further, the notification relay application may receive notification information from, for example, an external electronic device and provide the received notification information to a user.

The device management application may manage (e.g., install, delete, or update), for example, at least one function of an external electronic device (e.g., the electronic device 102 or 104) communicating with the electronic device (e.g., a function of turning on/off the external electronic device itself (or some components) or a function of adjusting the brightness (or a resolution) of the display), applications operating in the external electronic device, and services provided by the external electronic device (e.g., a call service or a message service).

According to an embodiment of the present disclosure, the applications 370 may include applications (e.g., a health care application of a mobile medical appliance or the like) designated according to an external electronic device (e.g., attributes of the electronic device 102 or 104). According to an embodiment of the present disclosure, the applications 370 may include an application received from an external electronic device (e.g., the server 106, or the electronic device 102 or 104). According to an embodiment of the present disclosure, the applications 370 may include a preloaded application or a third party application that may be downloaded from a server. The names of the components of the program module 310 of the illustrated embodiment of the present disclosure may change according to the type of operating system.

According to various embodiments, at least a part of the programming module 310 may be implemented in software, firmware, hardware, or a combination of two or more thereof. At least some of the program module 310 may be implemented (e.g., executed) by, for example, the processor (e.g., the processor 210). At least some of the program module 310 may include, for example, a module, a program, a routine, a set of instructions, and/or a process for performing one or more functions.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter. According to various embodiments, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable recoding media may be, for example, the memory 130.

An electronic device according to various embodiments, may include a communication interface, a sensor, a memory for storing health information on a user for the electronic device, and a processor, wherein the processor may be configured to obtain biometric information on a user corresponding to the electronic device using an external device functionally connected to a sensor or the electronic device, determine whether the user is in an emergency situation at least on the basis of the biometric information, and differently provide health information corresponding to the user depending on situations of the electronic device when it is determined that the user is in the emergency situation.

The processor may provide the health information using the first information providing method when the situation is the first situation, and provide the health information using a second information providing method when the situation is the second situation.

The processor may be configured to display at least a part of the health information through a display functionally connected to the electronic device depending on the situations.

The processor may be configured to transmit at least a part of the health information using the communication module depending on the situations.

The situation information may include surrounding information, obtained from the sensor or the external device, corresponding to the electronic device or the user.

The processor may be configured to obtain the situation information when it is determined that the user is in the emergency situation.

The processor may be configured to detect a distance between a target point and current position information on the basis of position information, and a change of the position, detect identification of a nearby person and existence or non-existence of a nearby person on the basis of the sensor information, and differently provide the health information at least on the basis of the distance with the target point, a change of the position, the identification of the nearby person, the existence or non-existence of nearby person, or a combination thereof.

The processor may be configured to display the health information and output a warning sound indicating that the user is in an emergency situation.

The processor may be configured to differently provide, on the basis of situations of the electronic device, a kind, a type, a level, a display method of the health information, a function related to the health information, or a combination thereof.

The processor may be configured to receive, from an information providing server, medical history information or treatment history information on a user corresponding to the electronic device, and determine whether the user is in the emergency situation at least on the basis of the biometric information, the medical history information, the treatment history information, or the combination thereof.

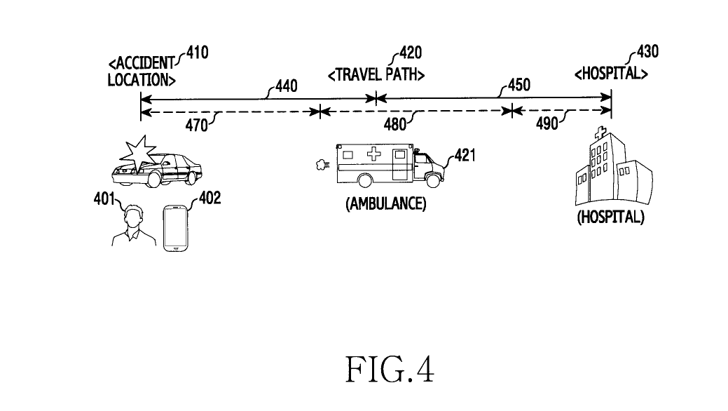

FIG. 4 is a diagram illustrating an example of a technique for providing health information, according to various embodiments. According to the technique, health information associated with a user 401 of an electronic device 402 may be provided when it is determined that the user 401 is in an emergency situation. For example, the present disclosure is for displaying first information related to a body of the user 401 to the electronic device 402 when the emergency situation occurs to the user 401, and providing second information related to the body of the user 401 when the user approaches within a predetermined distance of a designated point (e.g., a hospital 430).

According to various embodiments, the electronic device 402 may display different information on the basis of a distance between the hospital 430 and current position information, and a change of a position. Further, the electronic device 402 may display the different information by further considering the identification of a nearby person and/or whether a predetermined person (e.g., emergency responder) is present near the user 401. For example, the electronic device 402 may display first information related to the body of the user 401 while the electronic device 402 is located in a first section 440 (e.g., a first situation) of the travel path between the accident location 410 and the hospital 430. The electronic device 402 may provide health information (e.g., first information) using a first information providing method when the emergency situation is the first situation. The first information may include sensor information related to the body of the user 401 and include limited information indicating that the user 401 is in the emergency situation. For example, the first information may include a name, a blood type, blood pressure, and blood glucose of the user 401, a kind of emergency (e.g., traffic accidents, heart attacks, and falls), a first aid method according to a kind of emergency (e.g., cardiac massage and artificial respiration), a first aid method according to a state of the user 401 (e.g., a posture to be taken before the ambulance arrives, and medicines to be urgently administered), and emergency contacts.

The electronic device 402 may display second information related to the body of the user 401 when the electronic device is located in a second section 450 (e.g., a second situation) of the travel path between the accident location 410 and the hospital 430. The electronic device 402 may provide health information (e.g., second information) using a second information providing method when the emergency situation is the second situation. According to aspects of the disclosure, the first information and the second information may be same or different. The second information may be more detailed than the first information. For example, the second information may include the name, the blood type, the blood pressure, and the blood glucose, a kind of first aid (e.g., blood transfusion, and a defibrillator), existence or non-existence of medicine, existence or non-existence of an allergy, emergency contacts of the user 401. The electronic device 402 may transmit the second information and information including an expected hospital arrival time point to a representative contact (e.g., an e-mail) of the hospital 430.

According to various embodiments, the electronic device 402 may subdivide the travel path 420 from an accident location 410 to the hospital 430 to provide different information according to the distance. For example, the electronic device 402 may display, for example, an indication of a first section 470 of the travel path between the accident location 410 and the hospital 430, and first information related to the body of the user 401 when it is determined that the user 401 is in the emergency situation and the electronic device 402 is located in the first section.

The electronic device 402 may display, for example, an indication of a second section 480 of the travel path between the accident location 410 and the hospital 430, and second information related to the body of the user 401 when a distance from the user (or the electronic device 402) to the hospital 430 is within a first reference distance (e.g., 1000 m). The second information may include more detailed health information than the first information.

The electronic device 402 may display, for example, an indication of a third section 490 of the travel path between the accident location 410 and the hospital 430, and third information related to the body of the user 401 when a distance to the hospital 430 is within a second reference distance (e.g., 500 m). The third information may include more detailed health information than the second information. The electronic device 402 may transmit the second information, the third information, and user emergency information including an expected hospital arrival time point to a server that is associated with the hospital for viewing by the representative contact of the hospital 430. The transmission may take place in response to the electronic device 402 entering the second section 480 and the third section 490, and/or at any other time.

The accident location 410 may refer to a point where the emergency situation occurs to the user 401. For example, the accident location 410 may be a location where the user 401 had a traffic accident or a location where the user 401 suddenly falls down. When the user has a traffic accident or falls down, the user 401 may become unconscious. The electronic device 402 may determine whether the user 401 is in the emergency situation using sensor information measured by a sensor (e.g., the sensor module 240) included in the electronic device.

Further, the electronic device 402 may determine whether the user 401 is in the emergency situation using the sensor information received from a device (e.g., a wearable device) which the user 401 wears. Further, the electronic device 402 may determine whether the user 401 is in the emergency situation using the sensor information received from an external device (e.g., an IoT device, such as a thermometer and an air conditioner) around the electronic device 402. The sensor information may include biometric information of the user. For example, the sensor information may include health information on the user 401, for example, information of blood glucose, blood pressure, and electrocardiogram. Further, the electronic device 402 may determine that the user 401 is in the emergency situation when a specific button is pressed.

The electronic device 402 may output first information related to the body of the user 401 when it is determined that the user 401 is in the emergency situation. The electronic device 402 may display the first information on a screen, and output a warning sound indicating that the user is in the emergency situation. The warning sound may be a sound and vibration. The electronic device 402 may activate an LED in order to indicate the emergency situation. The first information corresponds to information which a paramedic who arrives at the accident location 410 or people around the accident location 410 and it may include limited information for protecting personal information of the user 401. Further, when receiving a signal from a device (e.g., device worn by only a paramedic) worn by a paramedic, the electronic device 402 may authenticate a nearby person (e.g., the person carrying the device) as a paramedic. For example, the first information may include the name, the blood type, a kind of first aid (e.g., blood transfusion, a defibrillator, sugar intake, insulin injection, an asthmatic breathing auxiliary apparatus, and a blood pressure drug), configured hospital information (e.g., a name, a position, and map), a medical history, a family history, and emergency contacts of the user 401. Further, the electronic device 402 may provide/make available a specific function of the specific function of the electronic device in an emergency, while disabling one or more other functions of the electronic device. For example, the electronic device 402 may provide a function of making a call to the emergency contacts included in the first information.

While the user 401 is transferred to the hospital 430 with an ambulance 421, the person who sees the electronic device 402 may be a paramedic. Further, the electronic device 402 may identify the nearby person as a paramedic when receiving a signal from a device which the paramedic wears. In this event, the electronic device 402 may display more detailed second information than the first information. For example, the second information may include the name, the blood type, the blood pressure, the blood glucose, a kind of first aid (e.g., blood transfusion, a defibrillator, sugar intake, insulin injection, an asthmatic breathing auxiliary apparatus, and a blood pressure drug), existence or non-existence of medicine, existence or non-existence of an allergy, configured hospital information (e.g., a name, a position, and map), a medical history, a family history, and emergency contacts of the user 401. Further, the electronic device 402 may allow some functions to be used so as to allow the paramedic to notify the emergency contacts that the user 401 is being transferred to the hospital 430. In addition, the electronic device 402 may allow the paramedic to execute a health application in the electronic device 402, and view biometric information (or health information) that is recorded by the health.

When approaching the hospital 430, the electronic device 402 may transmit user emergency information including the second information to the representative contact of the hospital 430. In addition, the electronic device 402 may include more detailed health information (e.g., the third information) than the second information and an expected time of arrival at the hospital in the user emergency information. For example, the third information may include the name, the blood type, the blood pressure, and the blood glucose, a kind of first aid, existence or non-existence of medicine, existence or non-existence of an allergy, whether pregnancy or not, a medical history, an operation history, a treatment history, configured hospital information, and emergency contacts of the user 401. Further, the electronic device 402 may transmit, to the hospital 430, biometric information measured by the electronic device 402 or a wearable device in real time. The electronic device 402 may directly transmit the user emergency information to the representative contact of the hospital 430, or transmit the information to the representative contact of the hospital 430 through a server.

The electronic device discussed below may refer to the electronic device 101 in FIG. 1 or the electronic device 201 in FIG. 2. Simply, for the convenience of the description, it is assumed in the following description that the electronic device described below is the electronic device 101 in FIG. 1. However, it is to be understood that any other suitable type of electronic device may instead perform the methods and tasks that are discussed below.

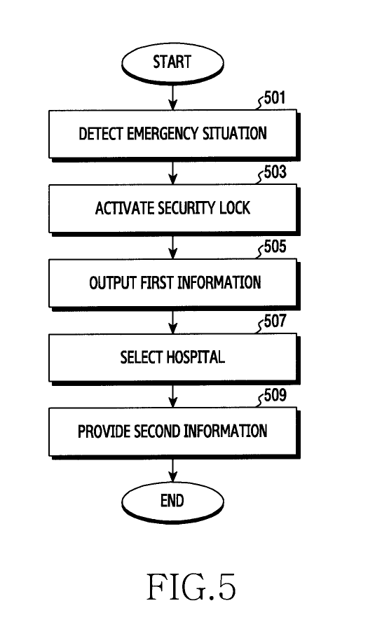

FIG. 5 is a flowchart of an example of a process, according to various embodiments. According to the process, the processor 120 may detect an emergency situation in operation 501. When a specific button (or a physical key) in the electronic device 101 is selected, the processor 120 may determine that an emergency situation exists. The specific button may be configured by the electronic device 101 or may be configured by the user. For example, the processor 120 may determine that the user in the emergency situation when an input, such as a long press of a side surface, a front surface, or a button (e.g., a home button, a volume key, and a lock key) included the side surface of the electronic device 101, is detected.

According to aspects of the electronic device may be configured to distinguish the long press input from a short press input that is performed at the same location. For example, when the user shortly presses a volume key once (e.g., presses the volume key for less than a second), the processor 120 may perform a function (e.g., a volume adjustment) corresponding to the volume key. When the volume key is long pressed over one second to be distinguished with the shortly pressing input, the processor 120 may determine that the volume key is used as an emergency key and determine that the user is in the emergency situation. According to various embodiments, the processor 120 may determine whether the user is in the emergency situation further based on sensor information that is collected in response to the specific button being selected.

According to various embodiments, the processor 120 may determine whether the user is in the emergency situation using first sensor information measured by a sensor (e.g., the sensor module 240) included in the electronic device 101. For example, the sensor may include an olfactory sensor, an ElectroMyoGraphy sensor, an electroNCPalogram sensor, an electrocardiogram sensor, an IR sensor, an iris sensor, a fingerprint sensor, a blood pressure sensor, a blood sensor, a Photo Plethysmography (PPG) sensor, and/or a gas sensor.

Further, the processor 120 may determine whether the user is in the emergency situation using second sensor information received from a device (e.g., a wearable device) which the user wears. Further, the processor 120 may determine whether the user 401 is in the emergency situation using third sensor information received from an external device (e.g., an IoT device such as a thermometer and an air conditioner) around the electronic device 101. The third sensor information may be received from the external device around the electronic device 101. The second information may be referred to as surrounding information.

The first to third sensor information may be distinguished according to a subject (e.g., an electronic device, a wearable device, and an external device) measuring the sensor information. The first to third sensor information may include identical or similar information related to the body of the user. For example, the first to third sensor information may include an indication of at least one of blood glucose, blood pressure, Photo Plethysmography (PPG), Galvanic Skin Responses (GSR), electrocardiography, body temperature, and skin moisture content. Since the first to third sensor information corresponds to information related to the body of the user, the first to third sensor information may refer to biometric information.

In operation 503, the processor 120 may activate a security of lock of the device by disabling at least some of the functions provided by the device. For example, the processor 120 may disable access to personal information of the user that is stored in the electronic device, while allowing the making of telephone calls to a selected telephone number (e.g., an emergency contact's telephone number).

More particularly, when the user had a traffic accident or suddenly falls down, the user 401 may be unconscious. In this event, personal information of the user recorded in the electronic device 101 is exposed or the electronic device 101 may illegally be used. In order to prevent this risk, the processor 120 may configure a security of the electronic device 101 when the emergency situation has been detected. That is, the security configuration may be for protecting personal information of the user and preventing illegal use of the electronic device 101. When the security is configured, the processor 120 may configure the electronic device 101 to be locked. Further, the processor 120 may allow only a part of a function related to the emergency situation during a lock configuration. For example, the processor 120 may control a call to be sent to only an emergency telephone number (e.g., emergency telephone number (e.g., 119), and a report telephone number (e.g., 112)), or phone number registered to emergency contacts.

According to various embodiments, the processor 120 may transmit an emergency message to a phone number registered as the emergency contact when the emergency situation has been detected. The emergency message may include a state (e.g., heart attacks, and falls) of the user or information related to an emergency situation.

In operation 505, the processor 120 may output first information. The processor 120 may display the first information on a screen, and output a warning sound indicating that the user is in the emergency situation. The first information may be information which a paramedic arrived at a position (e.g., the accident location 410) where the user is located and people around the user see. Therefore, the processor 120 may display limited information indicating that the user is in the emergency situation as the first information on the screen. For example, the first information may include a name, a gender, age, a blood type, a kind of an emergency, and emergency contacts of the user. For example, the paramedic or nearby people may select the appropriate first aid that the user needs based on the first information that is displayed on the screen.

In operation 507, the processor 120 may select a hospital to which the user is to be transferred. For example, the processor 120 may obtain the accident location and perform a search for nearby hospitals on the basis of the accident location. The processor 120 may search for hospitals located within a predetermined radius from the position information. The processor 120 may select at least one hospital from a plurality of hospitals that are identified as a result of the search. The selection may be performed on the basis of a movement direction of the user (and/or the electronic device).

According to various embodiments, the processor 120 may select a hospital, in which a first aid required by the user is possible, among the detected hospitals. For example, hospital information may previously be recorded in an information providing server. The hospital information may include at least one of a representative contact (e.g., an e-mail, and a phone number), a position, an emergency room situation, provided goods (e.g., a defibrillator) of the hospital, the number of times in which the user visits the hospital, and a combination of two or more thereof. The processor 120 may receive information of a list of nearby hospitals by transmitting the position information to the information providing server, and select at least one hospital from the list. The processor 120 may transmit the first information and the position information to the information providing server, and receive, from the information providing server, an identification of at least one hospital is appropriate for the user.

According to various embodiments, the processor 120 may select a hospital based on preference information that is stored in the electronic device 101. The preference information may be input into the electronic device by the user before the emergency situation taking place. The preference information may include an identification of a hospital in which the user usually goes or a hospital to which the user is to be transferred in case of an emergency. In this event, the processor 120 may determine the hospital on the basis of the configuration of the electronic device 101 without the position information.

According to various embodiments, the processor 120 may transmit an emergency message to a phone number registered as the emergency contact when the hospital has been determined. The emergency message may include at least one of a state (e.g., heart attacks, and falls) of the user, information (e.g., a position of the hospital, a hospital representative contact (e.g., a phone number)) of a hospital to which the user is being transferred, an expected hospital arrival time point, or a combination of two or more thereof.

In operation 509, the processor 120 may provide second information. For example, when the hospital is determined, the processor 120 may transmit the second information to a representative contact that is associated with the selected hospital. Further, the processor 120 may request to transmit the second information to the representative contact of the hospital by the information providing server. The processor 120 may transmit an indication of the selected hospital and the second information to the information providing server. The information providing server may then forward the second information to the representative contact of the hospital on the basis of the hospital information.

The second information may include the name, the blood type, the blood pressure, and the blood glucose, a kind of first aid (e.g., blood transfusion, and a defibrillator), existence or non-existence of medicine, existence or non-existence of an allergy, and emergency contacts of the user 401. In addition, the second information may further include estimated time of arrival at the selected hospital. The processor 120 may transmit the second information to the representative contact of the hospital on the basis of the hospital information received from the information providing server. The processor 120 may display the second information on the display 160. According to the embodiment, the processor 120 may display the second information on the display 160 when the user approaches within a predetermined distance with the hospital.

Below, table 1 shows an example of the first information and the second information.

TABLE 1

| Information | Type | Description |
|---|---|---|
| First | Personal | Name, gender, age |
| information | information | |
| | Administration | Information on medicine for first aid |
| | information | |
| | Blood glucose | Hypoglycemia shock doubt |
| | Blood pressure | Identify emergency situations due |
| | | to blood pressure |
| Second | Allergy | Allergy items |
| information | | |
| | Body information | Height and weight of patients required |
| | | during first aid |
| | Blood type | Prepare an emergency blood transfusion |
| | Heart disease | Heart disease |
| | Exercise trend | Daily, weekly, and monthly exercise |
| | Diet habit | Water, coffee, alcohol, calories, menu |
| | Heart rate | Usual resting heart rate information |
| | stress | Stress trend |
| | SpO2 | Information of oxygen saturation |
| | Hospital visit | Check recent health information |
| | record | |
| | Comment of a | It is possible to input and transmit a |
| | paramedic | state which a paramedic determines |

According to various embodiments, the processor 120 may provide at least a part of the obtained sensor information as first information and provide at least a part of the obtained sensor information as second information. For example, the processor 120 may allow an indication that the user is in an emergency situation to be included in the first information, and allow more detailed health information than the first information to be included in the second information. According to aspects of the disclosure, the first information and the second information may be same or different. In some implementations, the second information may include at least some of the first information.

According to various embodiments, the processor 120 may provide, on the basis of situations for the electronic device, a kind, a type, a level, a display method of the health information, a function related to the health information, or a combination thereof. For example, the processor 120 may select first information to be provided first and/or second information to be provided after the first information, on the basis of a kind, a type, a level, a display method of the health information, and a function related to the health information.

The processor 120 may receive biometric information (e.g., first information, and second information) from the user through the input/output interface 150, and extract the biometric information from an application. Furthermore, the processor 120 may receive, from the user, emergency contacts, an exercise schedule of the user, a an indication of dietary habits of the user, an indication of the degree of stress which the user normally experiences, and a hospital visitation record through the input/output interface 150. Further, the processor 120 may select an application for extracting biometric information from the user. In some implementations, the processor 120 may use the selected application to extract the biometric information periodically or in real-time.

According to various embodiments, the processor 120 may determine the application capable of obtaining the biometric information of applications installed in the electronic device 101, and obtain the biometric information from the determined application. The processor 120 may identify information related to the body of the user, from information obtained from individual applications or a combination thereof. The processor 120 may determine a kind of an application capable of extracting information related to the health, download the application from an external server, and install the application.

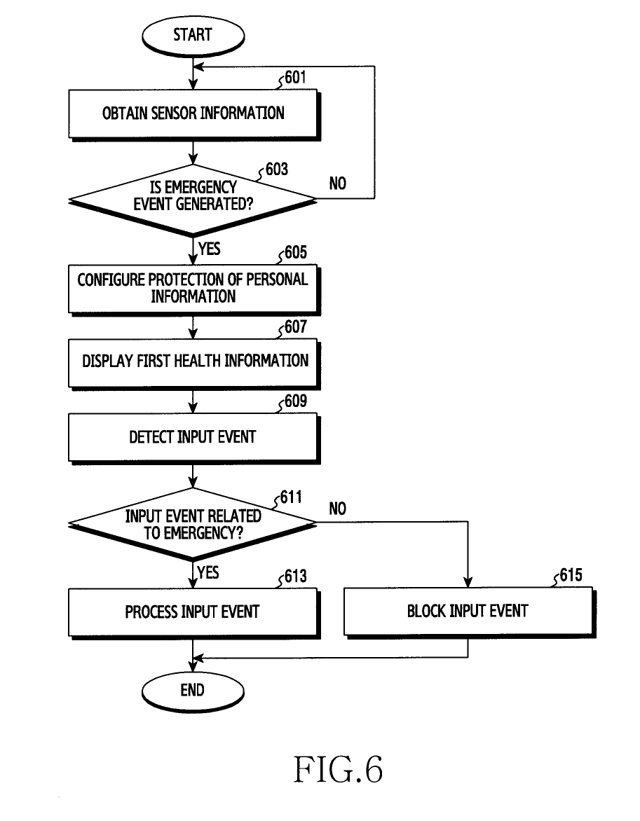

According to various embodiments, the processor 120 may receive medical history information or treatment history information on the user from a hospital server or the information providing server. In this event, the processor 120 may receive the medical history information. The medical history information may identify one or more health conditions of the user and/or identify past treatments that the user has received. The user may configure to agree to provide information to the hospital, or agree to provide information to the electronic device 101. The processor 120 may determine whether the user is in the emergency situation on the basis of at least one of the biometric information, the medical history information, the treatment history information, or a combination of two or more thereof. FIG. 6 is a flowchart of an example of a process, according to various embodiments. According to the process, the processor 120 may obtain sensor information (or biometric information) related to the user in operation 601. For example, the sensor information may include at least one of blood glucose, blood pressure, Photo Plethysmography (PPG), Galvanic Skin Responses (GSR), electrocardiography, body temperature, and skin moisture content, or a combination of two or more thereof.

According to various embodiments, the processor 120 may detect an emergency situation using the obtained sensor information. For example, the processor 120 may measure first sensor information related to the body of the user periodically or in real time using a sensor (e.g., the sensor module 240) included in the electronic device 101. The processor 120 may determine whether the user is in an emergency situation on the basis of the first sensor information. For example, the processor 120 may determine that the user is in an emergency situation based on detecting that the user's current blood glucose level is higher or lower than usually measured blood glucose level. As another example, the processor 120 may determine that the user is in an emergency situation when another metric, such as blood pressure deviates from a predetermined reference value (e.g., a normal figure). For example, the reference value may be to have a predetermined range.

Further, the processor 120 may periodically or in real-time receive second sensor information from a device which the user wears. The second sensor information may include information measured by the device which the user wears, and may include, for example, information such as blood glucose, blood pressure, and electrocardiography. For example, the user always wears a wearable device which can measure the information such as blood glucose, blood pressure, and electrocardiography, and the wearable device may periodically or in real time transmit the measured second sensor information to the electronic device 101. The processor 120 may determine whether the user is in an emergency situation on the basis of the second sensor information. In addition, the processor 120 may determine whether the user is in the emergency situation by considering both the first sensor information and the second sensor information.

Further, the processor 120 may periodically or in real time receive third sensor information from an external device around the electronic device 402. The external device refers to a device wiredly/wirelessly connected to the electronic device 101. The external device may include at least one of household appliances, electronic devices (such as wearable devices, devices of other users), health care, remote metering, smart homes, and devices related to smart cars. The external device may include one or more devices which can share information with the electronic device 101 through a network and/or a direct connection.

Further, the processor 120 may receive biometric information from the user through the input/output interface 150, or via the application. For example, the processor 120 may receive input from the user which identifies one or more of an exercise schedule of the user, a dietary habit(s) of the user, a degree of stress which the user normally experiences, and a hospital visitation record. Additionally or alternatively, the processor 120 may receive an application for obtaining information from the user and/or detecting biometric information of the user. The processor 120 may use the application obtain the biometric information periodically or in real time.

In operation 603, the processor 120 may determine whether an emergency event has been generated. For example, when a specific button (or a physical key) previously included in the electronic device 101 is selected, the processor 120 may determine that the emergency event has been generated. Further, the processor 120 may determine whether the emergency event has been generated on the basis of the sensor information. For example, the processor 120 may determine whether the user is in the emergency situation using at least one among the first to third sensor information.

According to various embodiments, the processor 120 may determine whether the user is in the emergency situation on the basis of sensor information when the specific button has been selected. For example, when the sensor information indicates that the user is not in an emergency situation, despite the specific button being selected, the processor 120 may determine that the user is not in the emergency situation. Further, when the sensor information indicates that the user is in an emergency situation, the processor 120 may determine that the user is in the emergency situation.

The processor 120 may perform an operation 605 when the emergency event is generated and may perform operation 601 again when the emergency event is not generated. When it is determined that the emergency event is not generated, the processor 120 may store the obtained sensor information in the memory 130. The processor 120 may calculate average health information for the user on the basis of sensor information stored in the memory 130 during a predetermined period.

When it is determined that the emergency event is generated, the processor 120 may configure personal information protection in operation 605. The personal information protection may be for protecting personal information of the user and preventing illegal use of the electronic device 101. When the personal information protection is configured, the processor 120 may configure the electronic device 101 to be locked. Further, the processor 120 may allow only a part of a function related to the emergency situation during the lock configuration. The processor 120 may be operated in a sleep mode during the lock configuration. The processor 120 may transmit the emergency message to a phone number registered as an emergency contact when it is determined that the emergency event is generated.

In operation 607, the processor 120 may display first health information. The processor 120 may display the first health information on a screen, and output a warning sound indicating that the user is in the emergency situation. The processor 120 may output the warning sound so as to notify nearby people that the user is in the emergency situation. The first health information may be information which a paramedic arrived at a position (e.g., the accident location 410) where the user is located and people around the user see. Therefore, the processor 120 may display limited information indicating that the user is in the emergency situation as the first health information on the screen. For example, the first health information may include a name, a gender, age, a blood type, a kind of an emergency, a first aid method based on a kind of the emergency, and emergency contacts of the user. The kind of the emergency may be estimated by the processor 120 using the sensor information. The processor 120 may continuously display the first health information without turning off the screen even though a predetermined time interval passes. The processor 120 may be operated in the sleep mode when the first health information is displayed.

In operation 609, the processor 120 may detect an input event. The event relates to use of the electronic device 101, and may be an input event such as pressing a home button and touching a screen. For example, the display 160 may display a user interface screen including the first health information. The user interface screen may include one or more items including the first health information.

In operation 611, the processor 120 may determine whether the event is related to an emergency. The processor 120 may perform operation 613 when it is determined that the event is related to the emergency and may perform operation 615 when it is determined that the event is not related to the emergency.

When it is determined that the event is related to the emergency, the processor 120 may process the event in operation 613. For example, the processor 120 may identify a user interface element that is selected by an input that caused the event to be generated and determine whether user interface element is related to the emergency, and may perform a function related to the selected item when the selected item is related to the emergency. For example, when the selected item is for contacting an emergency contact, the processor 120 may initiate a communications session with the emergency contact (e.g., initiate a telephone call).

When it is determined that the event is not related to the emergency, the processor 120 may block (e.g., ignore) the event in operation 615. For example, the processor 120 may determine whether the item selected on the user interface screen is related to the emergency, and may not perform the function for the selected item when the item selected on the user interface screen is not related to the emergency.

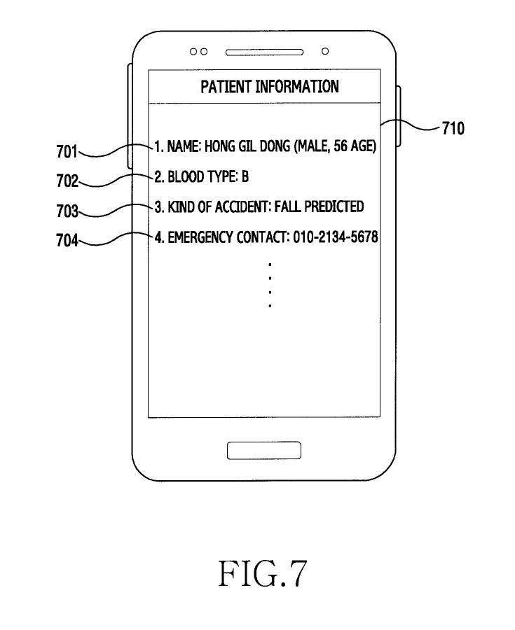

FIG. 7 illustrates an example of a first health information according to various embodiments. Referring to FIG. 7, the processor 120 may display a first user interface 710 including first health information. For example, the first user interface 710 may include user's personal information 701, a blood type 702, a kind of an accident 703, and emergency contacts 704 as the first health information. The first health information may be displayed at an emergency situation generation point (e.g. the accident location 410) and include only limited information indicating that a user is in an emergency situation. For example, the user's personal information 701 may include a name (Hong Gil Dong), a gender (male), and age (56) of the user in order to protect the user's personal information. The blood type 702 may be marked in preparation for a case in which the user bleeds. The kind of the accident 703 refers to a kind of an emergency, and may be estimated by the processor 120 on the basis of the sensor information. For example, the processor 120 may estimate the kind of the accident as a fall when it is determined that a large shock is generated. The emergency contacts 704 may be a contactable phone number when the user is in the emergency situation and be, for example, phone numbers of family, friends, and acquaintances.

The processor 120 may make a call to the emergency contacts 704 when a touch input is generated on the emergency contacts 704. Further, in a state in which the first user interface 710 is displayed, the processor 120 may determine whether the input event is processed, and may not perform, when an event which is not related to the emergency is generated, a function for the generated event.

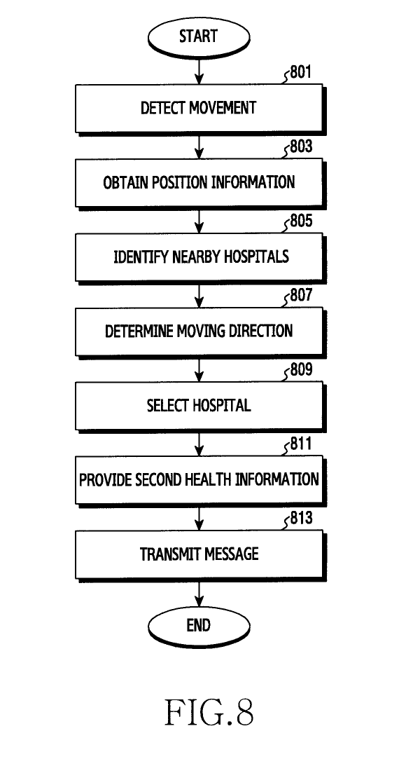

FIG. 8 is a flowchart of an example of a process, according to various embodiments. According to the process, the processor 120 may detect a movement in operation 801. The processor 120 may determine whether the processor 120 (or the electronic device 101) has moved from the location of an accident after a first health information is displayed. The detection of whether the processor 120 (or the electronic device 101) has moved may be performed in order to determine whether the user is being transferred to a hospital. For example, the processor 120 may detect whether there is the movement on the basis of sensor information obtained from a sensor (e.g., a GPS sensor, an acceleration sensor, and a motion sensor).

In operation 803, the processor 120 may obtain position information. The processor 120 may obtain position information through the communication interface 170. The processor 120 may periodically or in real-time obtain the position information when the movement has been detected.

In operation 805, the processor 120 may perform a search of nearby hospitals on the basis of the position information. For example, the processor 120 may search for hospitals located within a predetermined radius from the position information. According to various embodiments, since the user is in the emergency situation, the processor 120 may search only for hospitals that have an emergency room where the user can be treated. According to various embodiments, the processor 120 may transmit the position information to the information providing server and receive information on nearby hospitals. The hospital information received from the information providing server may also be information of the hospital including the emergency room.

In operation 807, the processor 120 may determine a movement direction. The processor 120 may determine the movement direction on the basis of sensor information obtained from a sensor (e.g., a GPS sensor, a gyro sensor, and an acceleration sensor).

In operation 809, the processor 120 may select one of the hospitals identified as a result of executing operation 805 on the basis of the position information and the movement direction. For example, the processor 120 may determine a hospital matched with the movement direction among the detected nearby hospitals. For example, when the movement direction is southwest, the processor 120 may select a south-westerly hospital among the detected nearby hospitals.

Additionally or alternatively, the processor 120 may select a hospital, in which a first aid required by the user is possible, among the detected hospitals. For example, the processor 120 may select a hospital having medical equipment related to the emergency event and/or the type of first aid which the user requires.

Further, the processor 120 may display the nearby hospital information on the display 160, and receive a selection of one hospital of the nearby hospital information by a paramedic. The processor 120 may display at least one of a hospital name, a position, an emergency room situation, and provided goods (e.g., a defibrillator) when the nearby hospital information is provided.

According to various embodiments, the processor 120 may select another hospital as the electronic device 101 moves. For example, after determining the hospital, the processor 120 may change the hospital when position information obtained in real time is different from position information of the hospital. That is, after determining the hospital, the processor 120 may change the selected hospital when position information of the electronic device 101 is different from position information of the determined hospital even after a predetermined time interval passes. The processor 120 may select another hospital by repeatedly performing operations 803 to 809. Further, the processor 120 may change the hospital on the basis of a current position of the electronic device 101 and a current movement direction of the electronic device 101.

In operation 811, the processor 120 may provide second information (e.g., second health information). For example, then the hospital is determined, the processor 120 may transmit the second information to a representative contact of the hospital. The representative contact may include a telephone number and/or any other suitable type of address that is associated with the hospital. The second information may include the name, the blood type, the blood pressure, and the blood glucose, a kind of first aid (e.g., blood transfusion, and a defibrillator), existence or non-existence of medicine, existence or non-existence of an allergy, and emergency contacts of the user. In addition, the second information may further include an estimated time of arrival of the user at the hospital. Further, the processor 120 may transmit the second information to the representative contact of the hospital by using an information providing server. The processor 120 may transmit the determined hospital information and the second information to the information providing server, and the information providing server may then forward the second information to the representative contact of the hospital on the basis of the hospital information. According to the embodiment, the processor 120 may display the second information on the display 160 when the hospital is determined. According to the embodiment, the processor 120 may transmit the second information to the representative contact of the hospital when the user approaches within a predetermined distance with the hospital. According to the embodiment, when the determined hospital is changed, the processor 120 may transmit the second information to the representative contact of the changed hospital.

In operation 813, the processor 120 may transmit an emergency message. The processor 120 may transmit the emergency message to a phone number registered as an emergency contact in the memory of the electronic device. The emergency message may include at least one of a state of the user, information of a hospital to which the user is being transferred, and an expected time of arrival at the hospital.

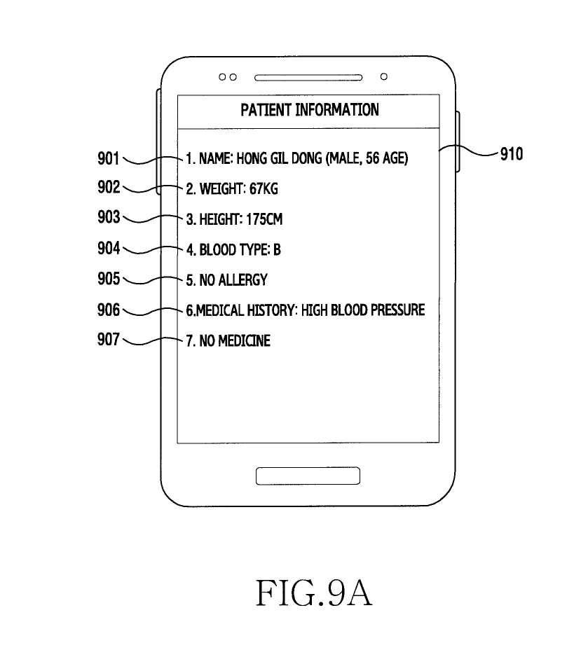

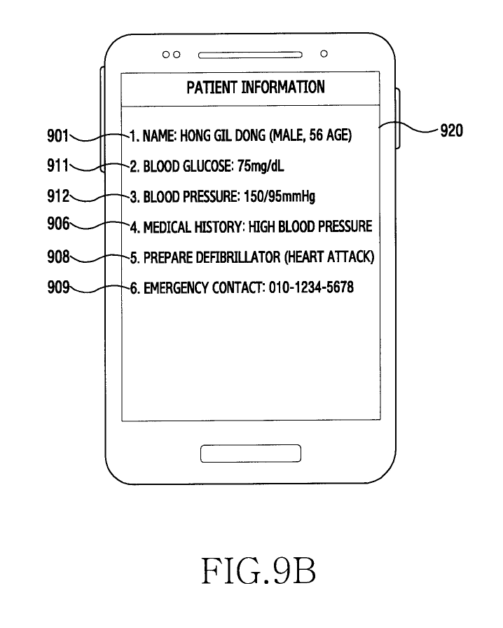

FIGS. 9A and 9B illustrate examples of the second health information according to various embodiments.

FIG. 9A illustrates a second user interface 910 including second health information. Referring to FIG. 9A, the second user interface 910 may include, as second health information, personal information 901, weight 902, height 903, a blood type 904, existence or non-existence of allergy 905, medical history 906, and existence or non-existence of medicine 907. The second health information is to be seen by a paramedic or hospital officials (e.g., a doctor and a nurse) and may include more detailed information than the first health information.

For example, the user's personal information 901 may include a name (Hong Gil Dong), a gender (male), and age (56) of the user in order to protect the user's personal information. The weight 902 and the height 903 are for notifying administration information appropriate for the user when a first aid is performed, and may be, for example, a capacity of anesthesia. The blood type 904 may be marked in preparation for a case in which the user bleeds. The existence or non-existence of allergy 905 may be for notifying information on a drug which should be avoided during the administration. The medical history 906 may be utilized when the first aid is performed. The existence or non-existence of medicine 907 may be utilized to prevent drug abuse.

FIG. 9B illustrates a third user interface 920 including second health information. Referring to FIG. 9B, the third user interface 920 represents another example of the second user interface 910. For example, the third user interface 920 may include personal information 901, blood glucose 911, blood pressure 912, medical history 906, required goods 908, and emergency contacts 909 as the second health information. That is, the processor 120 may selectively provide, according to situations, a kind, a type, a level, and a display method of health information and a function related to the health information. The blood glucose 911 and the blood pressure 912 may be utilized to perform a first aid appropriate for the user.

The processor 120 may make a call to the emergency contacts 909 when a touch input is generated on the emergency contacts 909. According to various embodiments, the processor 120 may display the second health information in a situation in which the user approaches within a predetermined distance with the hospital or the user arrives at the hospital.

According to various embodiments, when the user arrives at the hospital, a doctor or a nurse may operate the electronic device 101 for a state of the user. The processor 120 may determine a part of a function to be executed when the user arrives at the determined hospital. For example, the processor 120 may execute an application related to health when an item such as blood glucose or blood pressure is selected in the third user interface 920.

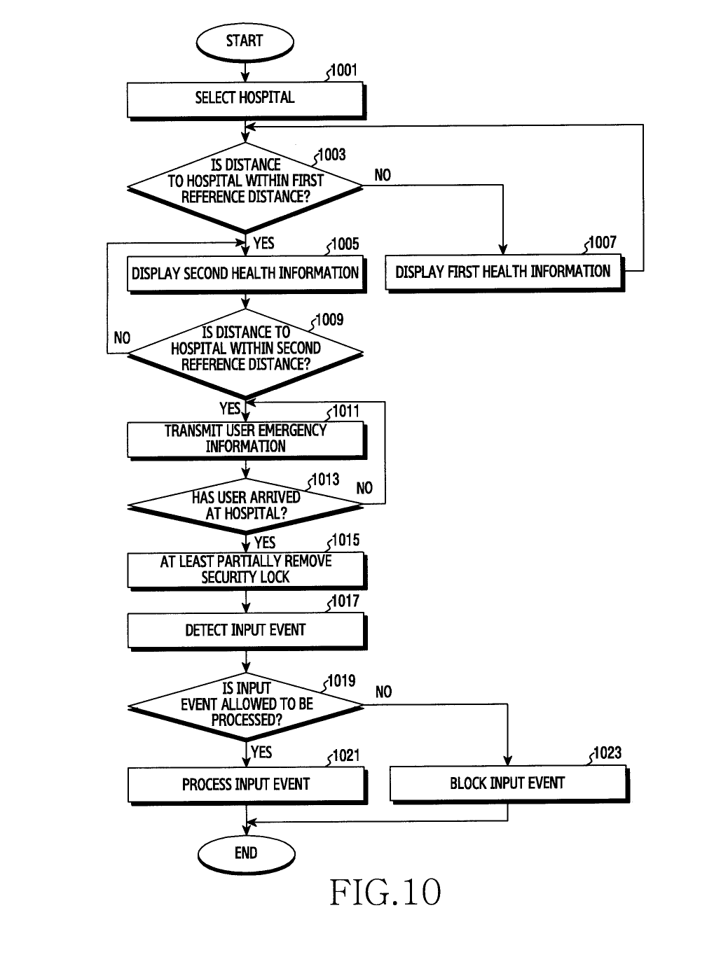

FIG. 10 is a flowchart of an example of a process, according to various embodiments. According to the process, the processor 120 may select a hospital in operation 1001. Operation 1001 may be performed in the same or similar manner as operation 809.

In operation 1003, the processor 120 may determine whether the current location of the processor 120 (or electronic device) is within a first reference distance. The processor 120 may calculate how far away from the hospital the current position information is, and determine whether the calculated distance is within the first reference distance.

The processor 120 may perform operation 1005 when the distance from the hospital is within the first reference distance, and perform operation 1007 when the distance from the hospital is out of the first reference distance. For example, when it is assumed that the first reference distance is 1000 m, a case in which the distance from the hospital is within the first reference distance may be a case in which a position of the electronic device 101 is less than or equal to 1000 m from the hospital. Further, when the distance from the hospital is out of the first reference distance, the position of the electronic device 101 may exceed 1000 m from the hospital.

As discussed with respect to FIG. 4, while the user 401 is being transferred to the hospital 430 with the ambulance 421 the person who sees the electronic device 402 may be a paramedic. In operation 1005, the processor 120 may provide on the screen second health information that is more detailed than the first health information. That is, the processor 120 may display the second health information on the screen when it is sure that the person who sees the electronic device 402 is the paramedic. Further, when it has authenticated a nearby person as a paramedic, the processor 120 may allow some functions of the electronic device 402 to be used (e.g., voice call functions, text messaging functions, etc.) in order to permit the paramedic to notify the user's emergency contact(s) that the user 401 is being transferred to the hospital 430. According to aspects of the disclosure, the contact information of the user's emergency contacts may be stored in the memory of the phone.

In operation 1007, the processor 120 may display first health information on the screen. Operation 1007 may be identical or similar to operation 505 in FIG. 5 or operation 607 in FIG. 6. That is, the processor 120 may display limited information indicating that the user is in the emergency situation as the first information on the screen.

In operation 1009, the processor 120 may determine whether the current location of the processor 120 (or electronic device) is within a second reference distance, on the basis of the position information. The processor 120 may calculate how far away from the hospital the processor 120 (or electronic device) is, and determine whether the calculated distance is within the first reference distance.

The processor 120 may perform operation 1011 when the distance from the hospital is within the second reference distance, and perform operation 1005 when the distance from the hospital is out of the second reference distance. For example, when it is assumed that the second reference distance is 500 m, a case in which the distance from the hospital is within the second reference distance may be a case in which a position of the electronic device 101 is less than or equal to 500 m from the hospital. Further, when the distance from the hospital is out of the second reference distance, the position of the electronic device 101 may be 500 m to 1000 m from the hospital.

In operation 1011, the processor 120 may transmit user emergency information to a representative contact that is associated with the selected hospital. The user emergency information may include at least one of the first information, the second information, and an expected time of arrival at the hospital. Additionally or alternatively, the user emergency information may further include, as information transmitted to the hospital, information required for providing first aid to the user, as well as health information associated with the user.

According to various embodiments, operation 1009 is not performed, and operation 1011 may be performed by being included operation 1005. For example, when the distance from the hospital is within the first reference distance, the processor 120 may display the second health information on the screen and transmit the user emergency information to a representative contact of the hospital.

In operation 1013, the processor 120 may determine whether the user has arrived at the hospital. For example, the processor 120 may determine that the user has arrived at the hospital when the position of the determined hospital is identical or similar to the current position of the electronic device 101 (or processor 120). The processor 120 may periodically or in real time determine whether the user has arrived. Further, when determining the hospital, the processor 120 may calculate an expected hospital arrival time point by considering the position information and time, and determine whether the user arrives at the hospital during a predetermined time interval from the expected hospital arrival time point. The predetermined time interval from the expected hospital arrival time point may be five minutes before or after the expected hospital arrival time point.

According to various embodiments, the processor 120 may change the determined hospital on the basis of the position information of the electronic device 101. For example, the processor 120 may change the hospital when position information obtained in real time is different from position information of the determined hospital. The processor 120 may determine whether the hospital is changed in at least one-time point while operations 1003 to 1011 are performed, and change the determined hospital. If the hospital has been changed, the processor 120 may determine that the user arrives at the hospital when the position of the changed hospital is identical or similar to a current position of the electronic device 101. When the hospital has been changed, the processor 120 may again calculate the expected hospital arrival time and determine whether the user arrives at the hospital during a predetermined time interval from the expected hospital arrival time point.

The processor 120 may perform operation 1015 when the user arrives at the hospital, and perform operation 1011 again when the user does not arrive at the hospital. When the user does not arrive at the hospital, the processor 120 may determine whether the hospital is changed. The processor 120 may transmit user emergency information to the representative contact of the changed hospital when the hospital has been changed.

When the user arrives at the hospital, the processor 120 may at least partially remove a security lock that is placed on the electronic device 101 in order to permit a doctor or a nurse to operate the electronic device 101 in order to identify a state of the user. In some implementations, the processor 120 may determine which functions of the electronic device 101 are to be unlocked when the user arrives at the determined hospital.

In operation 1017, the processor 120 may detect an input event. The event may be generated as a result of a pressing of a home button and touching the screen of the electronic device 101.

In operation 1019, the processor 120 may determine whether the event is allowed to be processed based on a type of the event. For example, the event may be allowed to be processed when it is an event related to the user's health.

The processor 120 may perform operation 1021 when the event is allowed to be processed and the processor 120 may perform operation 1023 when the event is not allowed to be processed.

In operation 1021, the processor 120 may process a function for the event when the event is allowed to be processed. For example, in response to the input event, the processor 120 may execute an application related to the user's health. Referring to FIG. 9B, the processor 120 may execute an application related to health when an item such as blood glucose or blood pressure is selected in the third user interface 920. Therefore, a doctor or a nurse may identify health information which is not displayed on the display 160 by using the application.

In operation 1023, the processor 120 may block a process for the event when the event is not allowed to be processed.

An operation method of the electronic device according to various embodiments may include operations of: obtaining biometric information on a user corresponding to the electronic device from a sensor or an external device; determining whether the user is in an emergency situation at least on the basis of the biometric information; and selectively providing health information corresponding to the user depending on a situation of the electronic device when it is determined that the user is in the emergency situation.

The operation of providing may include operations of: providing the health information using the first information providing method when the situation is the first situation; and providing the health information using a second information providing method when the situation is the second situation.

The operation of providing may include an operation of displaying at least a part of the health information through a display according to the situations.

The operation of operating may further include an operation of transmitting at least a part of the health information using the communication module of the electronic device according to the situations.

The situation information may include information corresponding to the electronic device or the user obtained from the sensor or the external device.

The operation of operating may further include an operation of obtaining the situation information when it is determined that the user is in the emergency situation.

The operation of providing may include operations of: detecting a distance between a target point and current position information on the basis of position information, and a change of the position; detecting identification of a nearby person and existence or non-existence of a nearby person on the basis of the sensor information; and selectively providing the health information on the basis of at least one of the distance from the target point, a change of the position, the identification of the nearby person, and the existence or non-existence of the nearby person.

The operation of providing may include operations of: displaying the health information on the display; and outputting a warning sound indicating that the user is in the emergency situation.

The operation of providing may include an operation of: selectively providing, on the basis of situations for the electronic device, at least one of a kind, a type, a level, a display method of the health information, and a function related to the health information.

The operation method may include operations of: receiving, from an information providing server, medical history information or treatment history information on a user corresponding to the electronic device; and determining whether the user is in the emergency situation on the basis of at least one of the biometric information, the medical history information, and the treatment history information.

A computer readable recording medium according to various embodiments may include a program for performing operations of: obtaining biometric information on a user corresponding to the electronic device from a sensor or an external device; determining whether the user is in an emergency situation at least on the basis of the biometric information; and differently providing health information corresponding to the user depending on a situation of the electronic device when it is determined that the user is in the emergency situation.

Any of the modules or programming modules according to various embodiments of the present disclosure may include at least one of the above-described elements, exclude some of the elements, or further include other additional elements. The operations performed by the modules, programming module, or other elements according to various embodiments of the present disclosure may be executed in a sequential, parallel, repetitive, or heuristic manner. Further, some operations may be executed according to another order or may be omitted, or other operations may be added. Various embodiments disclosed herein are provided merely to easily describe technical details of the present disclosure and to help the understanding of the present disclosure, and are not intended to limit the scope of the present disclosure. Therefore, it should be construed that all modifications and changes or modified and changed forms based on the technical idea of the present disclosure fall within the scope of the present disclosure.

The above-described aspects of the present disclosure can be implemented in hardware, firmware or via the execution of software or computer code that can be stored in a recording medium such as a CD-ROM, a Digital Versatile Disc (DVD), a magnetic tape, a RAM, a floppy disk, a hard disk, or a magneto-optical disk or computer code downloaded over a network originally stored on a remote recording medium or a non-transitory machine-readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”. The terms “unit” or “module” referred to herein is to be understood as comprising hardware such as a processor or microprocessor configured for a certain desired functionality, or a non-transitory medium comprising machine executable code, in accordance with statutory subject matter under 35 U.S.C. §101 and does not constitute software per se.

Moreover, the embodiments disclosed in this specification are suggested for the description and understanding of technical content but do not limit the range of the present disclosure. Accordingly, the range of the present disclosure should be interpreted as including all modifications or various other embodiments based on the technical idea of the present disclosure.

What is claimed is:

1. An electronic device comprising:
a communication module;
a sensor;
a memory for storing health information on a user of the electronic device; and
a processor,
wherein the processor is configured to obtain biometric information on the user corresponding to the electronic device from an external device functionally connected to the sensor or the electronic device, determine whether the user is in an emergency situation at least on the basis of the biometric information, and differently provide health information corresponding to the user according to situations for the electronic device when the user is in the emergency situation.

2. The electronic device of claim 1, wherein the processor is configured to provide the health information using a first information providing method when the situation is a first situation, and provide the health information using a second information providing method when the situation is a second situation.

3. The electronic device of claim 1, wherein the processor is configured to display at least a part of the health information through a display functionally connected to the electronic device according to the situations.

4. The electronic device of claim 1, wherein the processor is configured to transmit at least a part of the health information using the communication module according to the situations.

5. The electronic device of claim 1, wherein the situation information comprises surrounding information corresponding to the electronic device or the user obtained from the sensor or the external device.

6. The electronic device of claim 1, wherein the processor is configured to obtain the situation information when it is determined that the user is in the emergency situation.

7. The electronic device of claim 1, wherein the processor is configured to detect a distance between a target point and current position information on the basis of position information, and a change of the position, detect identification of a nearby user and existence or non-existence of a nearby person on the basis of the sensor information, and differently provide the health information at least on the basis of the distance with the target point, a change of the position, the identification of the nearby user, the existence or non-existence of nearby person, or a combination thereof.

8. The electronic device of claim 1, wherein the processor is configured to obtain an input of the nearby user through the display functionally connected to the electronic device, and determine whether the user is in the emergency situation further on the basis of the input of the nearby user.

9. The electronic device of claim 1, wherein the processor is configured to differently provide, on the basis of situations for the electronic device, a kind, a type, a level, a display method of the health information, a function related to the health information, or a combination thereof.

10. The electronic device of claim 1, wherein the processor is configured to receive, from an information providing server, medical history information or treatment history information on a user corresponding to the electronic device, and determine whether the user is in the emergency situation on the basis of at least one of the biometric information, the medical history information, and the treatment history information.

11. A method of operating an electronic device, the method comprising:
obtaining biometric information on a user corresponding to the electronic device from a sensor or an external device;
determining whether the user is in an emergency situation at least on the basis of the biometric information; and
differently providing health information corresponding to the user depending on situations of the electronic device when the user is in the emergency situation.

12. The method of claim 11, wherein the providing comprises: providing the health information using a first information providing method when the situation is a first situation; and providing the health information using a second information providing method when the situation is a second situation.

13. The method of claim 11, wherein the providing comprises displaying at least a part of the health information through a display according to the situations.

14. The method of claim 11, further comprising:
transmitting at least a part of the health information using the communication module of the electronic device according to the situations.

15. The method of claim 11, wherein the situation information comprises surrounding information corresponding to the electronic device or the user obtained from the sensor or the external device.

16. The method of claim 11, further comprising:
obtaining the situation information when it is determined that the user is in the emergency situation.

17. The method of claim 11, wherein the providing comprises:
detecting a distance between a target point and current position information and a change of the position on the basis of position information;
detecting identification of a nearby user and existence or non-existence of nearby person on the basis of the sensor information; and
differently providing the health information at least on the basis of the distance with the target point, a change of the position, the identification of the nearby user, the existence or non-existence of the nearby person, or a combination thereof.

18. The method of claim 11, wherein the providing comprises: displaying the health information on the display; and outputting a warning sound notifying that the user is in the emergency situation through a speaker.

19. The method of claim 11, wherein the providing comprises differently providing, on the basis of situations for the electronic device, a kind, a type, a level, a display method of the health information, a function related to the health information, and a combination thereof.

20. The method of claim 11, further comprising:
receiving, from an information providing server, medical history information or treatment history information on a user corresponding to the electronic device; and
determining whether the user is in the emergency situation on the basis of at least one of the biometric information, the medical history information, and the treatment history information.
